(19) United States
(12) Patent Application Publication
(10) Pub. No.: US 2026/0115087 A1
(43) Pub. Date: Apr. 30, 2026

(54) MASSAGE DEVICE WITH NEGATIVE PRESSURE CAVITY AND A CONFORMABLE INSERT

(71) Applicant: BB 3000 M d.o.o., Šoštanj (SI)

(72) Inventors: Boštjan Buc, Mislinja (SI); Simon Bracic, Slovenska Bistrica (SI)

(21) Appl. No.: 19/432,543

(22) Filed: Dec. 24, 2025

Related U.S. Application Data
(63) Continuation-in-part of application No. 17/802,230.

(30) Foreign Application Priority Data
Feb. 27, 2020 (EP) 201598430.0

(51) Int. Cl. A61H 9/00; A61H 23/00; A61H 23/02

(52) U.S. Cl. CPC A61H 9/0057; A61H 23/006; A61H 23/0254; A61H 2201/0153; A61H 2201/0157; A61H 2201/1215; A61H 2201/1436; A61H 2201/1664

(57) ABSTRACT

A massage device includes a main body having a gripping section adapted to be held by a user, a massaging head, and an actuator configured to effect a reciprocating movement of the massaging head relative to the gripping section. The massaging head includes a negative pressure cavity connected to the suction pump and conveying negative pressure to an insert having a flexible part with contacting edge for contacting a body surface receiving therapeutic massage, and a rigid part for coupling the insert to the massaging head. Optionally, the flexible part collapses longitudinally in response to vacuum pressure and forms a more rigid reciprocal force transmission path from the massaging head to the contacting edge.

### CROSS-REFERENCE TO RELATED APPLICATIONS

This patent application is a continuation-in-part of U.S. patent application Ser. No. 17/802,230, filed Aug. 25, 2022, which is the national phase of PCT/EP2021/054891, filed Feb. 26, 2021, which claims the benefit of European Patent Application No. 20159843.0, filed Feb. 27, 2020, all of which are hereby incorporated herein by reference in their entireties.

### TECHNICAL FIELD

The present invention relates to massage devices that effect reciprocating movement a massaging head, and also to massaging head inserts for use with massage devices.

### BACKGROUND

Percussive massage may comprise rapid, percussive tapping, slapping and cupping of an area of the human body. A massage device for applying pressure to the body with the reciprocating motion of a massage head is known from U.S. Pat. Nos. 10,314,762 B1. 5,902,293 discloses a can body connected to a sucking pump to withdraw air from inside the can body, which is fitted with a vibrator. An apparatus to administer a skin care composition including a housing, a suction tip to engage the skin, a suction pump connected to a motor, a vibrator, and a power supply is known from US 2016/0074641 A1. Conventional percussive therapy can be overly aggressive, delivering strong impacts that may irritate or even damage sensitive or already injured tissue.

### SUMMARY

The present application discloses massage devices and massaging heads or inserts for providing a user-friendly and therapeutic massage device, and a method of operation. As known devices with various shapes of massage heads and/or inserts for them exhibit significant shortcomings related to the adhesion to the skin, counteraction of the oscillatory motion the suction force of the insert leading to displacement or air leakage, the massage devices disclosed herein aim to provide reliable and effective massage therapy on all areas of the body, including irregular body surfaces such as bones, tendons, and joints as well as soft tissue.

In one aspect, a hand-held massage device comprising a main body having a gripping section adapted to be held by a user, a massaging head, an actuator configured to effect a reciprocating movement of the massaging head relative to the gripping section, and a suction pump, wherein the massaging head comprises a negative pressure cavity connected to the suction pump.

Percussive massage therapy, which is applied by the reciprocating movement of the massaging head, provides strong, rapid, short-duration strokes. This action relieves muscle tension and increases blood flow to the affected area and aids in relieving pain in soft tissues. Cupping therapy generating local negative pressure on the skin increases blood circulation to the area where the cups are placed. This is known to relieve muscle tension, improve overall blood flow and promote cell repair.

Optionally, negative pressure can be applied simultaneously together with powerful strokes of a massaging head, which aids to combine cupping and percussive massage therapy in one device. This improves the efficiency of sports-related muscle recovery and pain therapy. In one embodiment, the negative pressure cavity is open towards a front end of the massaging head to apply a negative pressure on a massage recipient during the massage operation. In particular, the volume of the negative pressure cavity remains constant during the reciprocating movement of the massaging head relative to the gripping section.

The negative pressure cavity may be connected via a tube to a suction pump, wherein the suction pump is arranged on the main body. Due to the independent arrangement of the suction pump from the massage head, the massage head may be designed rather compact and robust. In particular, the suction pump could have an electrical drive or may be driven by the actuator effecting the reciprocating movement of the massaging head. The suction pump could be an electric diaphragm air pump.

In particular, the negative pressure cavity is directly connected to the suction pump via a tube. In particular, the volume of the tube remains substantially constant during the reciprocating movement of the massaging head. This arrangement facilitates a reduction of pressure variations in the negative pressure supply to the negative pressure cavity.

In particular, the gripping section is positioned below the massaging head. The gripping section may extend downwardly with respect to the massaging head. The gripping section may be arranged in the form of a pistol grip inclined to the direction of the reciprocating movement of the massaging head. The gripping section may be orthogonal to the direction of the reciprocating movement of the massaging head. This facilitates the handling of the massaging device with precision to ensure that a precise application of the massage. Further, this facilitates that the negative pressure cavity may be sealingly applied to the massage recipient's skin to enable that the negative pressure is established.

Optionally, the angle in between the extension of the gripping section and the direction of the reciprocating movement of the massaging head is in between 45 degrees and 90 degrees, preferably in between 45 degrees and 85 degrees, more preferably in between 70 degrees and 80 degrees.

In an embodiment, the suction pump is arranged in the gripping section of the main body. The suction pump may be arranged at the opposite side of the gripping section with respect to the actuator. The vacuum pump and the actuator are of a certain weight, and their arrangement at opposite sides of the grip provides a beneficial weight distribution. In particular, this arrangement may increase the rotational inertia of the device, which compensates backlash from the reciprocating movement.

The device may comprise a battery, which may be arranged in the gripping section. The battery may be arranged in between the suction pump and the actuator. This further improves the weight distribution. The battery may be arranged more distant to the massaging head than the suction pump and the actuator.

The massage device may be provided with a pneumatic valve, which enables adjusting of the level of negative pressure. The pneumatic valve may be part of the suction pump or may be provided in between the suction pump and massage head.

This could be done by measuring the negative pressure level i.e. with an air pressure sensor and adjusting the negative pressure to a desired level by controlling the opening of the pneumatic valve through a feedback loop. This allows the users to set the negative pressure level individually, for example depending on the type and intensity of the sport activity or depending on the body, which will receive the massage.

Optionally, an air pressure sensor is adapted to measure the negative pressure, and the opening of the pneumatic valve is adapted to be controlled by a controller through a feedback loop based on the measured negative pressure. In one embodiment, the pneumatic valve may proportionally open and close a connection from the negative pressure system to the environment with ambient pressure. The valve may be proportionally opened by the controller to the environment with ambient pressure, to increase the pressure in the negative pressure cavity, and may be proportionally closed by the controller to the environment, to increase the pressure in the negative pressure cavity.

In another embodiment, the pneumatic valve may proportionally open and close a connection in between the suction pump and the negative pressure cavity. The valve may be proportionally closed by the controller to increase the pressure in the negative pressure cavity, and may be proportionally opened by the controller to the environment, to increase the pressure in the negative pressure cavity. Increasing the pressure means altering the pressure in the negative pressure cavity such that it is closer to ambient pressure, while lowering the pressure means altering the pressure in the negative pressure cavity such that it is closer to a vacuum.

The air pressure sensor may be arranged in the negative pressure cavity or at the suction pump, or may be connected to the tube.

A release switch may be provided, which is adapted to be actuated by a user to open or close the pneumatic valve such that the negative pressure in the negative pressure cavity is quickly equalized to ambient pressure. This enables to end the negative pressure application immediately, such that the massage device may be removed from the massage recipient easily. The release switch may be arranged in the gripping section. By activating the release switch, a valve provided at the discharge port of the suction pump may be opened.

In another aspect, the massaging head comprises an insert and a base body, wherein the insert is removably arranged in the base body. By applying different inserts in the base body, different massaging options are offered to a user in a single device. A user can choose different inserts depending on the massage as desired.

In particular, the insert protrudes out of the base body in the direction of the reciprocating movement. In particular, this arrangement enables that only the insert comes into contact with the massage recipient. Optionally, the insert forms a part of the negative pressure cavity. In particular, the negative pressure cavity is formed in both the base body and the insert. The portion of the negative pressure cavity distant to the massage recipient may be formed by a cavity in the base body, while the portion of the negative pressure cavity proximal to the massage recipient may be formed by the insert. In particular, the tube is connected to the portion of the negative pressure cavity distant to the massage recipient. The portion of the negative pressure cavity proximal to the massage recipient may be adapted to different requirements by exchanging inserts with different proximal negative pressure cavity geometries.

The shape of the insert protruding from the base body may be generally ball-shaped, flat, fork-shaped, or cone-shaped. Purely percussive massaging inserts without negative pressure cavity could be used if the user prefers to apply only percussive massage. According to another aspect, cupping massage inserts with a negative pressure cavity may be provided. The cupping massage inserts may be U-shaped in their cross-section or have a cone-shaped opening. The cupping massage inserts may be used for a cupping massage application when activating the suction pump only. When activating the suction pump and the actuator, a combined cupping and percussive massage application is provided.

Moreover, the insert or the negative pressure cavity receiving the insert in the base body may be provided with a connector, which facilitates replacements of other inserts and retains them in the base body during the massage.

In particular, inserts can be made from a variety of materials, such as i.e. polymer, metal, glass, and composite, and may possess different hardness values.

The insert may comprise a contact element for contacting the massage recipient, wherein the contact element is made of a softer material than the remaining insert. In particular, the contact element forms an insert edge portion, which is adapted to come into contact with the massage recipient. The contact element may be made of silicone. The contact element is in particular provided along the opening in the insert towards the negative pressure cavity. This softer and thus deformable contact element allows better sealing the negative pressure cavity when in contact with the massage recipient. The soft edge portion may also improve the comfort for the massage recipient.

Optionally, the insert is at least partially arranged in the negative pressure cavity. In particular, the negative pressure cavity may be partially void despite the inserted insert. This may reduce the size, weight and production cost of the inserts, and provide an extra volume for the negative pressure, lowering pressure amplitudes. Further, the insert may protrude over the negative pressure cavity in the direction of reciprocating movement.

In one embodiment, the insert forms a part of the negative pressure cavity. Thus, the insert defines the form of the negative pressure cavity by providing the outer walls of the negative pressure cavity. Hence, it is possible to provide different shapes of negative pressure cavities by replacing the inserts in the base body of the massaging head.

Optionally, a sealing is provided in between the insert and the base body of the massage head. This may improve the fastening of the inserts in the base body of the massaging head, in particular by increasing friction forces in between the insert and the base body. Also, the sealing may reduce or avoid air leakage.

The insert may be held by a connector, such as a mechanical coupling, in the base body of the massage head.

In one embodiment, the negative pressure in the negative pressure cavity is adapted to hold the insert in the base body. This may eliminate the necessity of the usage of a connector for fastening the inserts in the base body of the massaging head.

In an embodiment, the actuator is arranged at least partially in the gripping section. This saves space and provides a compact massage device, which is easy to handle by the users.

In an alternative embodiment, the actuator is arranged above the gripping section.

According to an embodiment, the actuator comprises a crank drive having a drive shaft, which is eccentrically fixed in a crank body, wherein the crank body provides a bearing for a piston rod. Optionally, the diameter of the bearing is bigger than twice the radius of the eccentricity of the fixation of the drive shaft in the crank body. Based on lever rule, a small eccentricity allows gaining more percussive force from drive shaft of the motor; consequently a more efficient use of motor power. The relatively large bearing compared to the eccentricity may have a high mechanical durability. Furthermore, the inventive bearing design may reduce friction, and, thus, the de-vice may be operated at higher speed and/or with a stronger massaging force.

According to one embodiment, at least a rear end of the massaging head is formed as a piston guided in a bushing, wherein the actuator is connected via a pin in a hollow section in the rear end of the piston. This allows a size reduction of the moving components of the massage device and a compact design thereof. Moreover, the forces acting on the massaging head may be evenly distributed to the main body.

Optionally, the massage device comprises an acceleration sensor or pressure sensor or both configured to detect the acceleration of or pressure applied by the massaging head. Optionally, the massage device may further comprise a display indicating the pressure applied by the massaging head derived from the pressure sensor or the acceleration sensor. Accordingly, the user can control and adjust the desired pressure level. The display may be adapted to display the orientation of the massage device derived from the measured acceleration. In particular, the indicated orientation is the relative orientation in between massage device and the contact surface on a body part of the massage recipient. The orientation may be considered as beneficial, if it maximizes the contact surface between the massage head and body part. The beneficial orientation may be indicated on the display. Thus, the user may be guided to optimize the position of the device in a way to make the best use of the massage device. Optionally, the sensors are arranged at or in the massaging insert.

The massage head may have a weight of 20 g to 100 g, preferably 40 g to 60 g.

According to another aspect, a massaging insert forms a part of a negative pressure cavity. In particular, the negative pressure cavity is open towards the front of the massaging insert and comprises an open connection towards its rear end, such that the negative pressure provided in the base body of the massaging head is connected to the negative pressure cavity, when the massaging insert is connected to the base body. It should be understood that the term “negative pressure” is used throughout this application and the claims to means any air pressure that is below local atmospheric pressure.

The massage device may include a main body having a gripping section adapted to be held by a user, a massaging head, and an actuator configured to effect a reciprocating movement of the massaging head relative to the gripping section, wherein the actuator comprises a crank drive having a drive shaft, which is eccentrically fixed in a crank body, wherein the crank body provides a bearing for a piston rod, wherein the diameter of the bearing is bigger than twice the radius of the eccentricity of the fixation of the drive shaft in the crank body. The massage device may further comprise any one of the features specified above. The actuator may be arranged at least partially in the gripping section.

In another aspect, a method of operation of a massage device, in particular for a non-therapeutic massage application, includes moving the massaging head reciprocatingly relative to a gripping section and providing a negative pressure within a cavity in the massaging head. The massage device may have the features specified above.

In a further aspect, negative pressure is applied in a massaging head of a massage device in a percussive, in particular non-therapeutic massage application. In particular, the negative pressure may be provided by a suction pump.

The massage head comprises a conformable insert allowing reliable sealing, stability, efficient energy transfer and shock-load mitigation. The conformable insert comprises at least a flexible part and a rigid part for contacting the skin of the massage recipient. The flexible part includes a connecting part for connection to the rigid part, a flexible contact edge configured for contacting the skin and defining a contact area as well as the active massage area inside the circumference of the contact edge, and an adaptable, elastically deformable middle section between the connecting part and the flexible contact edge, which allows adaptation to contours of the body part in contact with the massage head. The rigid part is provided with suitable engaging means for installation into the massage head, and a connecting part for connection to the flexible part. The rigid part ensures safe installation, force and vacuum transmission, while the flexible part ensures adaptability of the conformable insert to the contours of the body part where it is placed/used and also retains the vacuum as the edge is reliably in contact with skin. The middle section of the flexible part is elastically deformable, which means that its temporary shape change during application of massage is self-reversing after the force is removed, so that the middle section returns to its original shape. In other words, the middle section recovers its shape when the negative pressure is removed.

The middle section can be shaped as a curved or a protruding part having a circumference smaller or larger than the edge, so that upon application of negative pressure and subsequent decrease of the distance between the upper section and the edge the middle section provides a spring-like, flexible and elastic deformation of at least part of the shape, usually by pronouncing the bulge or the protrusion and/or by increasing the curvature radius of the middle section. The middle section is longitudinally compressible in response to the negative pressure, when the suction pump is activated and the flexible edge is in contact with the part of the user's body. This effect creates sufficient pressure across the entire edge, ensuring a proper seal so that a vacuum can be reliably created inside the massage head. During operation, the flexible edge compensates for external forces and thus continuously follows the surface and adapts to it.

The geometry of the walls in the adaptable, elastically deformable middle section between the connecting part and the flexible contact edge is designed so that upon application of negative pressure, the walls of the middle section at least in a part of the insert move towards each other or even come into contact (i.e. collapse). After this, the air volume inside the insert does not change, even during oscillatory movement, until there is a change in the negative pressure. Depending on the surface where the insert is installed, the walls come into contact at least in a part of the insert or along the whole circumference. The middle section is thus trapped in-between the flexible contact edge and the rigid part of the insert, so that the forces are applied directly to the tissue surrounded by the contact edge.

The function of the massage head is reliable, comfortable and secure adhesion to the tissue, regardless of the complexity of the surface. The flexible part allows axial deformation, while remaining stable under vacuum, oscillation and external loads (movement of the massage device, massage delivered at an angle, etc.). Adhesion is achieved by the difference between ambient pressure and negative pressure inside the massage head.

The middle section may be provided with at least one bulge, curve or protrusion. Also, the middle section may comprise two or more bulges or protrusions, thus forming an accordion-like (bellows shape) or corrugated shape. The design of the middle section is arbitrary as long as it allows at least partial deformation as described above.

In some embodiments, the orientation of the bulge or the protrusion may be towards interior of the insert, meaning that the circumference or diameter of the middle section is smaller than the circumference or diameter of the edge and/or the upper section. In other possible embodiments, the orientation of the bulge or the protrusion may be towards exterior of the insert, meaning that the circumference or diameter of the middle section is larger than the circumference or diameter of the edge and/or the upper section.

This disclosed designs allow the insert to conform to anatomical contours, resist collapse under vacuum, and absorb mechanical shock. Compared to known rigid or soft-edge cups, the insert provides reliable sealing under dynamic percussion, reliable sealing on irregular surfaces (bones, tendons, joints), improved energy transmission efficiency, enhanced user comfort and safety through lower required vacuum levels, shock absorption reducing mechanical stress on both tissue and device components.

In some embodiments, the flexible edge comprises a circular cross section. In possible embodiments, the diameter of the flexible edge is at least two times greater than the thickness of the middle section.

The insert may further comprise a vacuum seal for ensuring vacuum and keeping the massage head installed in the device. The vacuum seal is a component known to the skilled person and is installed on the rigid part of the insert and shaped in any known manner. In this case, the rigid part of the insert also comprises a seat for accommodating the vacuum seal.

The material for the flexible part may be thermoplastic elastomer, silicone, rubber-like or any other flexible material. In some embodiments, the middle section and the flexible edge are unitarily formed of the same material. In possible embodiments, the rigid part may be made from plastic materials. The flexible and the rigid part may be joined in any suitable manner, such as by reversible joining, such as bonding, interlocking shapes or similar.

The shape of the edge for contacting the skin is arbitrary, wherein circular shapes are most common. In some embodiments, thus, the opening formed by the undeformed flexible edge has a circular shape. However, it is possible to design the edge and the corresponding insert in other cross-sections such as oval, square, rectangle, trapeze, and the like.

The massage device comprising the massage head with the insert as described above allows controlled and reliable application of vacuum while ensuring oscillatory motion to mobilize soft tissue.

These and other objects, advantages, purposes and features of the present disclosures will become apparent upon review of the following specification in conjunction with the drawings.

### BRIEF DESCRIPTION OF THE DRAWINGS

Various embodiments will now be further explained with reference to the figures.

FIG. 1 shows a side view of a massage device according to an embodiment;

FIG. 2 shows a sectional side view of a massaging head with an insert according to an embodiment;

FIG. 3 shows a sectional side view of a massaging head with an insert according to a further embodiment;

FIG. 4 shows a sectional side view of a massaging head with an insert according to a further embodiment;

FIG. 5 shows a sectional side view of an actuator;

FIG. 6 shows a top view of the actuator according to FIG. 5;

FIG. 7 shows a side view of a massage device according to a further embodiment;

FIG. 8 shows a side sectional view of an insert according to a further embodiment;

FIG. 9. shows a side elevation view of the insert of FIG. 8;

FIG. 10 shows a diagrammatic side elevation view of the insert of FIG. 8 that is held by a massage device and placed against a body part;

FIG. 11 shows an enlarged sectional view of the area designated XI in FIG. 11;

FIG. 12 is another diagrammatic side elevation view of the insert of FIG. 8 that is held by a massage device and placed against a body part under vacuum pressure;

FIG. 13 shows an enlarged sectional view of the area designated XIII in FIG. 12;

FIG. 14 shows an enlarged view of a flexible contact edge of the insert placed against a body surface;

FIG. 15 shows a transparency side elevation view of an insert according to a further embodiment;

FIG. 16 shows another transparency side elevation view of the insert of FIG. 15 shown placed against a curved body surface;

FIG. 17 shows a perspective view of an insert flexible part according to a further embodiment, shown placed in slight contact with a diagrammatic body part;

FIG. 18 shows a side perspective view of the insert and body part of FIG. 15, shown with the insert pressed against the body part;

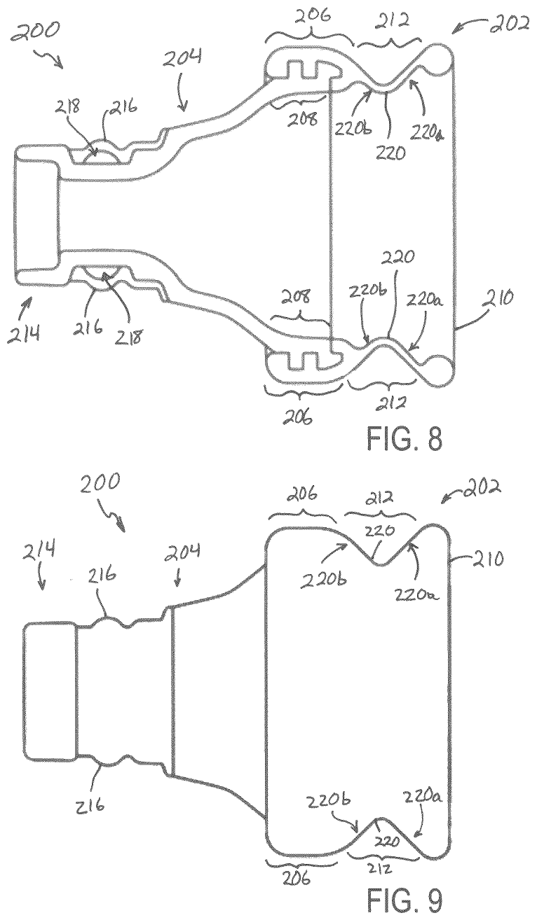

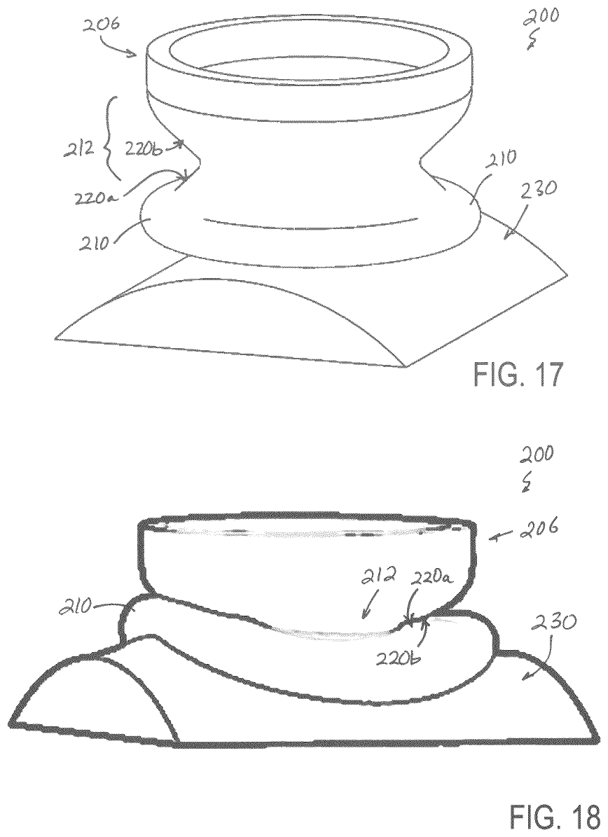

FIG. 17 shows a front perspective view of a flexible portion of the insert of FIG. 8, shown placed against a curved body part;

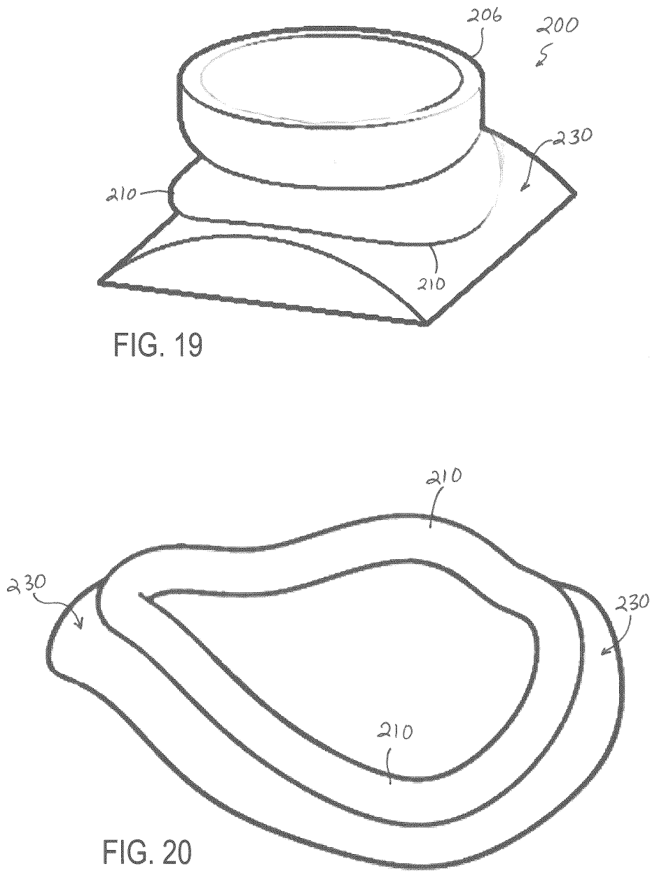

FIG. 18 shows a perspective view of the flexible insert portion of FIG. 17, shown conforming to the curved body part; and

FIG. 19 shows a side elevation view of the flexible insert portion and body part of FIG. 18; and

FIG. 20 shows a top-side perspective view of the conformable lip of a flexible insert portion in contact with a compound-curved body part.

### DETAILED DESCRIPTION

FIG. 1 shows a massage device 1 in the form of a portable electromechanical device that may be used for percussive therapeutic massage application, including the operation modes: rapid strokes, suction, and a combination of rapid strokes and suction.

The massage device 1 comprises a main body 2 with a platform 200 on which a bushing 17 for a massaging head 4 with a negative pressure cavity 6 having a body engaging opening 23 and a suction pump 7 are arranged. The bushing 17 of the massaging head 4 is arranged and fastened on the platform 200 via screws. The suction pump 7 is mounted stationary on the platform 200. The suction pump 7 might be provided with a pneumatic valve 27. The massaging head 4 is connected to the suction pump 7 via a tube 8 on a suction opening 60 of the massaging head 4.

The massage device 1 may comprise a negative pressure release switch 29 which may be actuated by a user to open the pneumatic valve, such that the negative pressure in the negative pressure cavity 6 is quickly equalized to ambient pressure.

The main body 2 has a gripping section 3 for a user to hold the massage device 1. The gripping section 3 is positioned below the platform 200. An actuator 5 configured to effect a reciprocating movement of the massaging head 4 relative to the gripping section 3 is partially arranged in the gripping section 3 and extends above the platform 200. It is also possible that the actuator 5 is arranged on the main body 2 above the platform 200. The length 26 of the reciprocating part of the massaging head 4 may be in between 50 mm to 200 mm, such as around 100 mm.

Through the reciprocating movement of the massaging head 4 extending from a retracted first position to a protruding second position, the massaging head 4 can apply rapid strokes on the chosen body region of the massage recipient in varying speeds defining stroke levels. After engaging the body engaging opening 23 of the massaging head 4 on the body of the massage recipient, through the operation of the suction pump 7, the air within the negative pressure cavity 6 of the massaging head 4 is partly evacuated to produce suction on the body surface of the massage recipient. Thus, the rapid stroke and suction modes can be operated simultaneously.

The massage device 1 may comprise an acceleration sensor 19, air pressure sensor 20 and a mechanical pressure sensor 21, which can be positioned in the vicinity of the actuator 5 or the massaging head 4. An air pressure sensor 20 may be provided within the negative pressure cavity 6 of the massaging head 4 to detect the air pressure within the cavity 6. Using the acceleration sensor 19, the velocity and position of the massaging head 4 may be estimated. The mechanical pressure sensor 21 may be positioned in between the actuator 5 and the gripping section 3, such that the force ap-plied by the actuator 5 may be determined and the pressure applied to the massage recipient can be estimated. An air pressure sensor 20 may be provided in the massaging head, in particular in between the base body 10 and an insert 9 of the base body 10.

The massage device 1 can comprise a user interface 22, for instance a touchscreen, which can be arranged on the gripping section 3 or on an enclosure (not shown) covering the part of the main body above the platform 200. By means of the user interface 22, the user can chose different massage treatment options such as rapid stroke, suction or simultaneous rapid stroke and suction massage. The user may also choose different massage options regarding the pressure level depending on the activity performed by the massage receiver before the massage such as running, cycling, yoga etc. The massaging options offered to the user could also depend on the health and wellness of the user, for example if the massage receiver has an injury or not. The massaging options could be chosen also depending on the level of muscle soreness and how hard or soft the muscle feels. The user may also choose massaging options with different negative pressure levels and stroke levels. The user interface 22 may also be provided on a remote device (e.g. smartphone) including an adapted application software. By choosing the desired massage treatment option on the user interface 22, negative pressure levels and stroke levels, with the engagement of the body engaging opening 23 of the massaging head 4 on the body of the massage recipient, the massaging device 1 will automatically adjust the negative pressure and stroke levels according to the chosen parameters.

The negative pressure diminishes automatically, when the body engaging opening 23 of the massaging head 4 disengages from the present body spot and engages on the same or another body spot of the massage recipient.

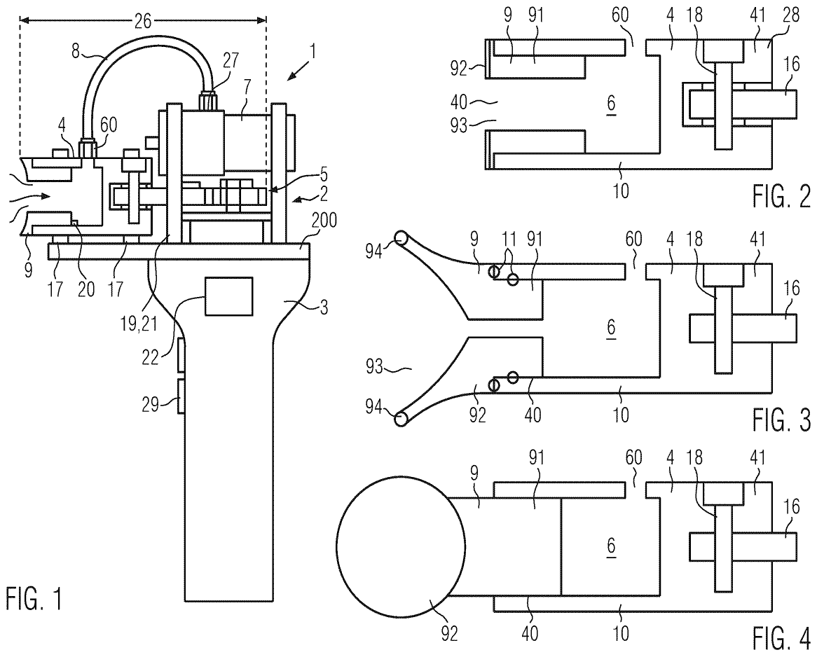

FIG. 2 shows a sectional side view of the massaging head 4 with an insert 9. The massaging head 4 comprises an insert 9 and a base body 10, wherein the insert 9 is removably arranged on the front end 40 of the massaging head 4 in the base body 10. The rear end 41 of the massaging head 4 is formed as a piston 28. A piston rod 16 of the actuator 5 is connected by means of a pin 18 placed in the massaging head 4.

Inserts 9 may have different sizes, forms, material properties and functions. For instance, an insert 9 may comprise a connector, which may lock the insert 9 by form or friction fit in the base body 10. Thus, the inserts 9 can be installed without any tool or screwing step. A rear insert portion 91 of the insert 9 is fully inserted in the base body 10. The rear insert portion 91 may be a cylindrical body and made of a flexible polymer. A front insert portion 92 of the insert 9 is protruding out of the base body 10 in the direction 100 of the reciprocating movement. The front insert portion 92 may comprise a circular opening 93.

FIG. 3 shows a sectional side view of the massaging head 4 with an insert 9 having a front insert portion 92 with a cone-shaped opening 93. The rear insert portion 91 of the insert 9 is fully inserted in the base body 10. A contact element 94 in the form of a silicone ring is provided around the opening 93.

A sealing 11 may be provided in between the base body 10 of the massaging head 4 and the insert 9. The diameter of the opening 93, the length and angulation of the cone of the insert 9 lying outside of the massaging head 4 can vary.

FIG. 4 shows a sectional side view of the massaging head 4 with an insert 9 having a tip with no opening. This insert 9 is merely held by the negative pressure in the negative pressure cavity 6, but does not provide any cupping function. The front insert portion 92 of the insert 9 protruding out of the base body 10 may comprise a ball-shaped or flat-shaped or fork-shaped tip.

The length of the rear insert portions 91 extending within the base body 10 of the massaging head 4 may vary as well. This length can be almost equal to the length of the negative pressure cavity 6 or smaller than the length of the negative pressure cavity 6. For the former case, the inserts 9 may have a suction opening (not shown) in their rear insert portions 91 corresponding to the same spot of the suction opening 60 of the massaging head 4.

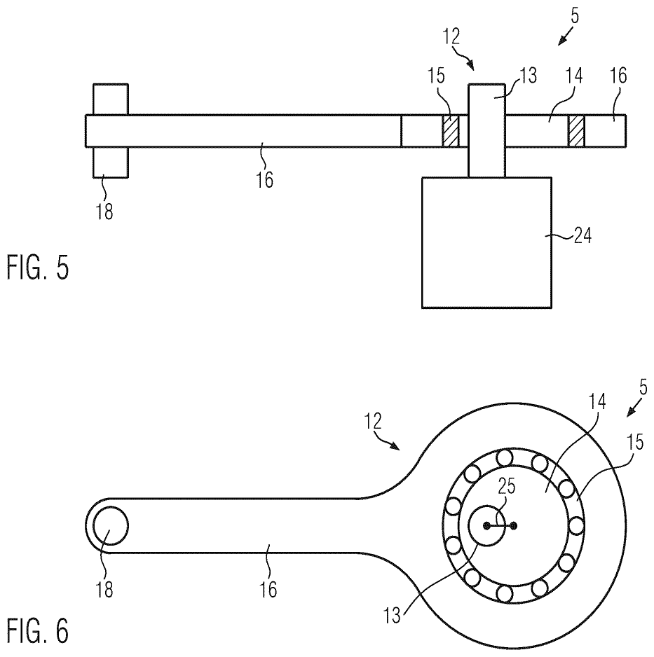

FIG. 5 illustrates a sectional side view of an actuator 5, which is partially shown in FIG. 1. The actuator is configured to effect a reciprocating movement of the massaging head 4. The actuator 5 comprises a crank drive 12, having a drive shaft 13 connected to a motor 24, such as a brushless DC motor. The drive shaft 13 is eccentrically fixed in a crank body 14. The crank body 14 provides a bearing 15 for a piston rod 16. The piston rod 16 is mechanically connected to the massaging head 4 with the pin 18 as shown in FIGS. 2, 3, and 4.

FIG. 6 illustrates a top view of the actuator 5. The eccentricity 25 defined as the distance between the center of the crank body 14 and the drive shaft 13 may be in between 3 mm to 9 mm, preferably around 6 mm.

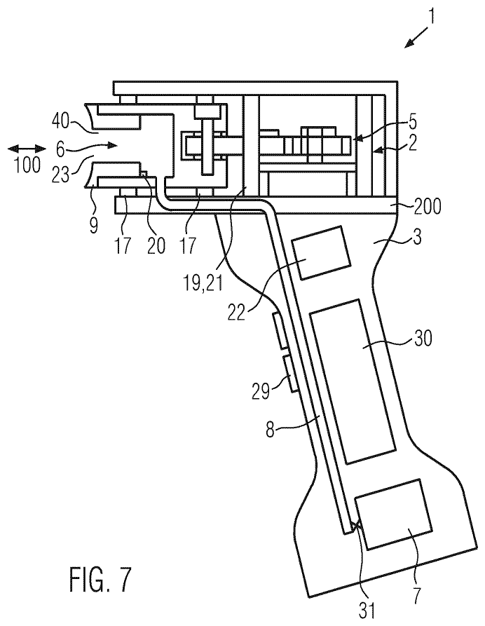

FIG. 7 shows a further embodiment of the massage device 1. The suction pump 7 is arranged in the gripping section 3 at the opposite side of the gripping section 3 with respect to the actuator 5. A battery 30 is arranged in the gripping section 3 and electrically connected to both the actuator 5 and the suction pump 7. The tube 8 directly connects the suction pump 7 and the negative pressure cavity 6. A pneumatic valve 31 is provided as part of the suction pump 7. A controller may receive a feedback signal from the air pressure sensor 20 and control the pneumatic valve 31 in a feedback loop. In particular, the controller may open or close the valve depending on the difference in between a set target pressure and the measured pressure from the air pressure sensor. The controller may be a PID-controller or an on/off-controller.

Actuation of the release switch may open the pneumatic valve 31 towards the environment, such that the pressure in the negative pressure cavity is equalized to ambient pressure. The gripping section 3 extends in an angle of roughly 85 degrees regarding the direction 100 of the reciprocating movement of the massaging head 4.

The massage device 1 may comprise an air quality sensor (not shown). With the air quality sensor user can measure exactly the air quality of the room or area, where the user treats himself with the massage device 1. This could be shown to the user through the user interface 22 so that the user can change location or ventilate the room in order to obtain the best possible relaxing experience.

The massage device 1 may be linked to a remote device, particularly to an adapted application software (app) such as health or fitness apps via a communication interface in the massage de-vice. The user may be notified with a suitable massage operation option depending on the type and duration of the sport type registered in the fitness app. The user may input information through the user interface 22, for example the touchscreen of the massage device 1 or an app in a remote device, after the massage operation, regarding the parameters of the operation or type of sport activity or health problem or level and type of pain remained on a specific muscle group after the current massage operation. Depending on this information, the user can receive a feedback with a recommendation for a further massage treatment. This input data for each user may be stored in the massage device 1 or in the app on the remote device. A specific recovery program may be displayed and selectable on the user interface 22. Training videos for using the massage device 1 may be displayed on the user interface 22.

Referring now to FIGS. 8 and 9, another insert 200 has a flexible part 202 for contacting the skin of the massage recipient and a rigid part 204 for coupling directly to a reciprocating actuator or to a massage head portion that is reciprocated by the actuator, such as may be provided by the massage device 1 described above. In the illustrated embodiment, the flexible part 202 includes a proximal region 206 forming a connecting part for connection to a distal end portion 208 of the rigid part 204. The flexible part 202 has a readily deformable distal contact edge 210 for directly contacting the skin, thereby defining a contact area, which forms an active massage area inside the circumference of the contact edge 210. Located between the contact edge 210 and the connecting part 206 is an elastically deformable middle section 212 that allows or facilitates the contact edge's adaptation to contours of a body part, including body parts having compound curves. The rigid part 204 has a proximal end portion with suitable engaging structure 214 for installation into a massage head or coupling directly to an actuator. Engaging structure 214 of rigid part 204 may include a sealing flange or ring 216 received in a seat 218 to form a vacuum seal that ensures vacuum pressure is maintained through the insert 200, and which helps secure the insert 200 to the massage head or actuator. A receiving opening of the massage head or actuator (not shown in FIG. 8 or 9) receives the engaging structure 214 including the sealing flange or ring 216, which establishes the seal with the inner surfaces defining the receiving opening of the massage head or actuator.

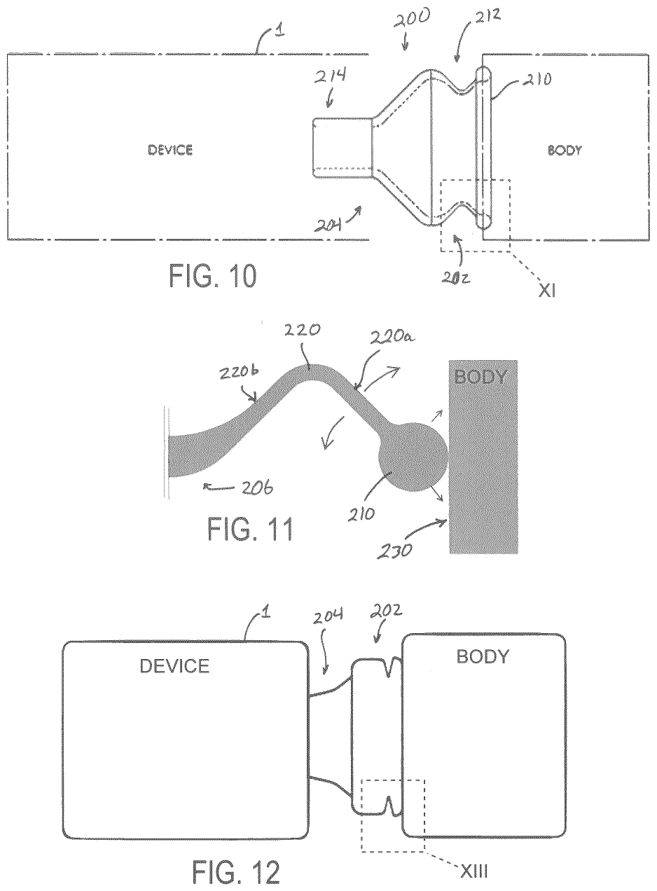

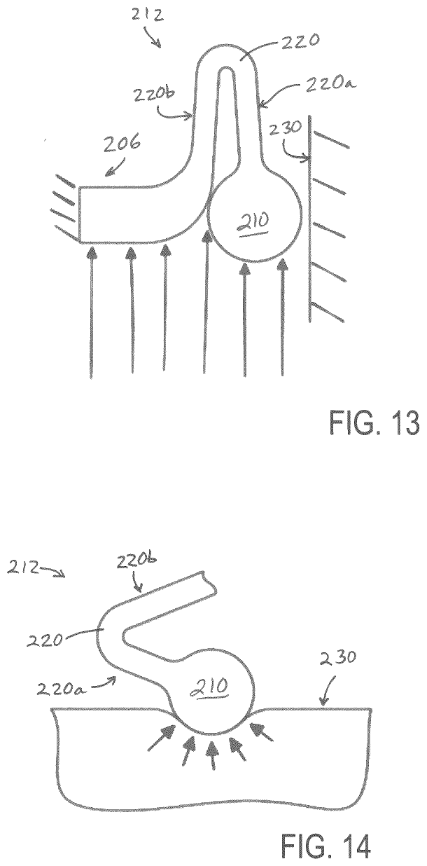

The middle section 212 is formed of a relatively thin annular wall 220 that transitions to the flexible part's thicker connecting part 206 and contact edge 210. The thin annular wall is readily adaptable and elastically deformable so that upon application of negative pressure, a distal portion 220a of the wall 220, in at least a part of the insert, move towards a proximal portion 220b of the wall 220 (FIG. 12), or the distal and proximal wall portions 220a, 220b may even come into contact (i.e. collapse, see FIG. 13). In FIG. 13, atmospheric air pressure is depicted with generally parallel upwardly-pointing lines. In this collapsed configuration, the air volume inside the insert does not change, even during oscillatory movement, until there is a change in the negative pressure. Therefore the collapsing movement, upon application of sufficient vacuum pressure, is characterized by axial movement of the contact edge 210 and distal wall portion 220a toward the connecting part 206 and proximal wall portion 220b, such as may be envisioned with reference to FIGS. 9-13. Depending on the shape of the body surface that the contact edge 210 is placed against, the entire circumference of the distal wall portion 220a may contact the entire circumference of the proximal wall portion 220b. This would be most likely to occur when the contact edge is placed along a planar or more nearly planar body surface (e.g., FIGS. 10 and 12), and/or at lower vacuum pressures (i.e., stronger vacuum). In such an arrangement, reciprocating forces imparted to the rigid part 204 are transmitted directly to the contact edge 210 and the body tissues along and near the contact edge 210. Reactive forces in the body tissues are depicted with a series of arrows in FIG. 14. Because the middle section 212 has essentially collapsed onto itself as shown in FIG. 13, the middle section 212 is not acting as a shock-absorber in this configuration, and the full reciprocating forces are imparted to the body tissues as long as full contact is substantially maintained between the massage recipient's skin and the contact edge 210.

The flexibility of middle section 212 and contact edge 210 cooperate to allow similar functionality when contact edge 210 is placed against non-planar body surfaces, such as shown in FIGS. 16-20. Contact edge 210 is able to conform to simple curved body surfaces 230 such as those cylindrical or near-cylindrical shapes that may be found along the limbs or sides of the chest (FIGS. 16-19), as well as to compound curve shapes that may have different combinations of convex regions, different combinations of concave regions, or combinations of convex and concave regions (FIG. 20). At the highest points of the semi-cylindrical surface encountered by contact edge 210, the wall portions 220a, 220b of the middle section 212 are in contact with each other, while at other points the wall portions 220a, 220b are only partially moved closer towards each other, such as best shown in FIG. 18, but which also may be understood with reference to FIGS. 16 and 19.

As best shown in FIGS. 16 and 18-20, contact edge 210 is widely adaptable to simple or complicated surface undulations of the body, remaining capable of establishing and maintaining a satisfactory vacuum seal against the skin in these regions and thus achieving similar reciprocating force transmission as when engaged with more planar body surfaces, although typically with less than the full circumferences of the middle section's distal and proximal wall portions 220a, 220b being drawn together.

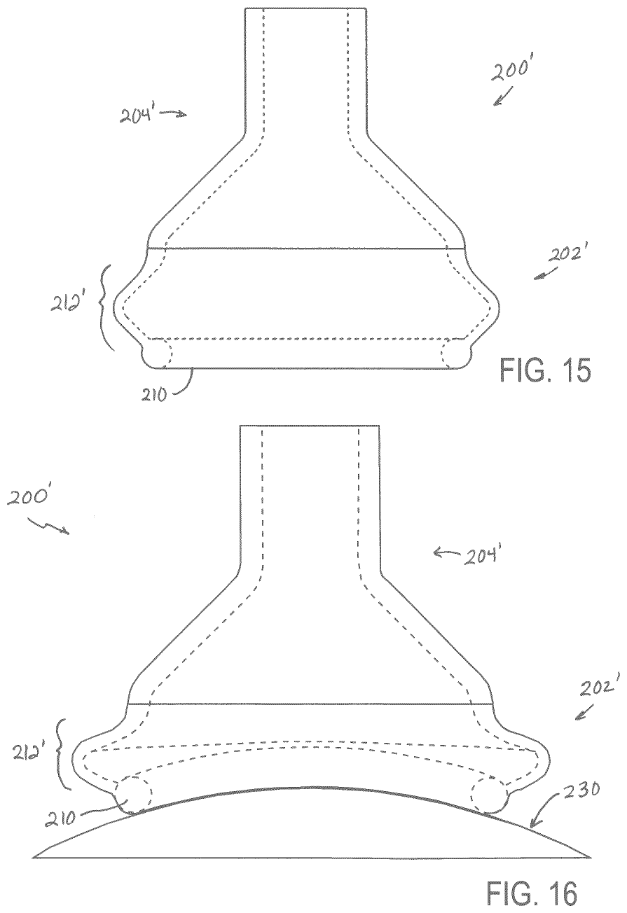

In the illustrated embodiments of FIGS. 8-12 and 17-19, the middle section 212 has a single curved region that is annular and concave in shape when viewed from the exterior. However, it will be appreciated that similar results may be achieved with an insert 200′ having a middle section 212′ with a single curved region that is convex in shape when viewed from the exterior, such as shown in FIGS. 15 and 16. Thus, the circumference and diameter of the middle sections 212, 212′ are either smaller or larger than the circumference and diameter of the contact edge 210. It is further envisioned that similar function may be achieved with a substantially cylindrical middle section having one or more stiffening ribs or frangible regions designed to bend and buckle in defined areas in response to sufficient negative (vacuum pressure. It will further be appreciated that the flexible part's middle section may be formed with two or more bulges or protrusions, thus forming an accordion-like (bellow shape) or corrugated shape with larger-diameter regions alternating with narrower-diameter regions, such as in an undulating curved pattern or in a series of corners or tight radiuses working in a hinge-like manner.

In all of these variants, the middle sections 212, 212′ are longitudinally compressible in response to the negative pressure, when the suction pump is activated and the flexible contact edge 210 is in sufficient contact with the surfaces 230 of the user's body. The geometry of the wall 220 in the middle section 212 is designed so that upon application of negative pressure, the wall portions 220a, 220b of the middle section at least in a part of the flexible part 202 move towards each other or even come into contact (i.e. collapse) with each other or with an inboard surface of the contact edge 210 contacting the proximal portion 220b of the wall 220, or even the flexible part's proximal region 206 as shown in FIG. 13. Depending on the shape of the body surface 230 where the insert is installed, the wall portions 212a, 212b can come into contact or nearly into contact at least in a part of the insert, or along the whole circumference, which is schematically depicted in FIGS. 12 and 13.

In the illustrated embodiments, and as best shown in FIGS. 8, 10, 11, and 13-16, the flexible contact edge 210 has a circular cross section. The diameter of the flexible edge may be at least two times greater than the thickness of the relatively thin annular wall 220 of the middle section 212, and may be at least three or four times greater such as shown in FIGS. 11 and 13-16. The round or circular cross section of the contact edge 210, along with the location where annular wall 220 transitions to the contact edge, allows for rolling movement of the contact edge 210 along the body surface 230, such as depicted with arrows in FIG. 11. When the insert 200 is pressed against the body surface 230 and/or when a seal is established between the body surface 230 and the flexible contact edge 210 and vacuum pressure is applied inside the insert 200, the proximal wall portion 220b will move toward the distal wall portion 220a, which in turn will pivot toward the body surface (as depicted with a curved larger arrow pointing diagonally up and right in FIG. 11) as the contact edge 210 rolls along the body surface 230 in an upward direction as viewed in FIG. 11. When the vacuum pressure is released and/or the insert 200 is permitted to expand its middle section 212, the opposite movement results, where the proximal wall portion 220b will move away from the distal wall portion 220a, which in turn will pivot away from the body surface (as depicted with a curved larger arrow pointing diagonally down and left in FIG. 11) as the contact edge 210 rolls along the body surface 230 in a downward direction as viewed in FIG. 11.

The flexible part 202 and the rigid part 204 of the insert 200 are joined together with an interlocking shape of annular ribs and channels as shown in FIG. 8. The connecting part 206 of the flexible part 202 extends over the distal end portion 208 of the rigid part 204 to create a shape-engaging complementary fit that is substantially sealed against vacuum leaks, although it will be appreciated that an additional seal such as an O-ring or flange or a curable sealant material may be used. The connection between the flexible part 202 and the rigid part 204 may be designed in any other suitable manner, and may be designed so that the flexible part 202 may be readily removed and replaced with a fresh flexible part 202, such as to account for wear or damage, for hygiene reasons, or to install a flexible part 202 having a different shape that may be specialized for a particular region of the body, for example.

The invention is not limited to the embodiments described herein, but can be amended or modified without departing from the scope of the present invention as defined by the appended claims, as interpreted according to the principles of patent law including the doctrine of equivalents.

1. A vacuum-percussive massage device comprising:
a main body having a gripping section adapted to be held by a user;
a reciprocating actuator;
a suction pump; and
a conformable insert having a rigid part for coupling to the actuator and a flexible part configured to contact the skin of a massage recipient;
wherein the conformable insert defines a negative pressure cavity connected to the suction pump;
wherein the flexible part of the conformable insert comprises:
a connecting portion for coupling to the rigid part;
a flexible contact edge configured for contacting the skin along a body part and defining an active massage area; and
an elastically deformable middle section between the connecting portion and the flexible contact edge, the middle section configured to permit the flexible contact edge to adapt and conform to a non-planar surface of the body part;
wherein a circumference of the middle section is different from a circumference of the flexible contact edge, and wherein the middle section is collapsible in response to negative pressure imparted by the suction pump while the flexible contact edge conforms to the non-planar surface;
wherein the rigid part of the conformable insert comprises:
a proximal engaging portion for attachment to the actuator; and
a distal connection portion for coupling to the connecting portion of the flexible part.

2. The vacuum-percussive massage device according to claim 1, wherein the middle section has at least one concave region, wherein the circumference of the middle section is less than the circumference of the flexible contact edge.

3. The vacuum-percussive massage device according to claim 1, wherein the suction pump is mounted in the main body, and wherein the suction pump is operable to generate and maintain the negative pressure at a level that maintains the middle section in a collapsed state while the flexible contact edge conforms to the non-planar surface and the actuator reciprocates the conformable insert.

4. The vacuum-percussive massage device according to claim 1, wherein the middle section comprises an elastically deformable wall having a distal region that moves axially toward a proximal region in response to the negative pressure generated by the suction pump when the flexible contact edge is conformed to the non-planar surface.

5. The vacuum-percussive massage device according to claim 4, wherein the negative pressure generated by the suction pump is sufficiently low and the deformable wall is sufficiently flexible that the distal region of the deformable wall moves axially into contact with the proximal region of the deformable wall when the flexible contact edge is conformed to the non-planar surface.

6. The vacuum-percussive massage device according to claim 1, wherein the middle section comprises a plurality inward-extending and outward-extending portions forming an accordion-like shape.

7. The vacuum-percussive massage device according to claim 6, wherein the inward-extending and outward-extending portions are curved in shape.

8. The vacuum-percussive massage device according to claim 1, wherein the flexible contact edge has a width that is greater than the width of an elastically deformable wall defining the middle section.

9. The vacuum-percussive massage device according to claim 8, wherein the flexible contact edge comprises a round cross section.

10. The vacuum-percussive massage device according to claim 9, wherein the flexible contact edge comprises a circular cross section.

11. The vacuum-percussive massage device according to claim 1, comprising a vacuum seal established where the proximal engaging portion of the rigid part couples to the connecting portion of the flexible part.

12. The vacuum-percussive massage device according to claim 11, wherein the proximal engaging portion of the rigid part comprises a first interlocking shape and the connecting portion of the flexible part comprises a second interlocking shape configured to engage said first interlocking shape.

13. The vacuum-percussive massage device according to claim 12, wherein said first and second interlocking shapes each comprise at least one annular ridge and at least one annular groove.

14. The vacuum-percussive massage device according to claim 11, comprising another vacuum seal established where the rigid part couples to the actuator.

15. The vacuum-percussive massage device according to claim 1, wherein the flexible part of the conformable insert comprises a thermoplastic elastomer, silicone, or a rubber-like material.

16. The vacuum-percussive massage device according to claim 15, wherein the middle section and the flexible contact edge are unitarily formed of the same material.

17. The vacuum-percussive massage device according to claim 1, wherein the rigid part of the conformable insert comprises a resinous plastic material.

18. A vacuum-percussive massage device comprising:
a main body having a gripping section adapted to be held by a user;
a reciprocating actuator;
a suction pump; and
a conformable insert having a rigid part for coupling to the actuator and a flexible part configured to contact the skin of a massage recipient;
wherein the conformable insert defines a negative pressure cavity connected to the suction pump;
wherein the flexible part of the conformable insert comprises:
a flexible contact edge configured for contacting the skin along a body part and defining an active massage area; and
an elastically deformable middle section between the rigid part and the flexible contact edge, the middle section configured to permit the flexible contact edge to adapt and conform to a non-planar surface of the body part;
wherein a circumference of the middle section is different from a circumference of the flexible contact edge, and wherein the middle section is longitudinally collapsible in response to negative pressure imparted by the suction pump while the flexible contact edge conforms to the non-planar surface.

19. The vacuum-percussive massage device according to claim 18, wherein the flexible contact edge has a rounded shape and a width that is greater than the width of an elastically deformable wall that forms the middle section, and wherein the suction pump is operable to generate and maintain the negative pressure at a level that maintains the middle section in a longitudinally collapsed state while the flexible contact edge conforms to the non-planar surface and the actuator reciprocates the conformable insert.

20. A vacuum-percussive massage device comprising:
a main body having a gripping section adapted to be held by a user;
a reciprocating actuator;
a suction pump; and
a conformable insert having a proximal end comprising a rigid base part for coupling to the actuator and a free distal end portion extending distally from said rigid base part, the free distal end portion comprising a flexible part configured to contact the skin of a massage recipient;
wherein the conformable insert defines a negative pressure cavity connected to the suction pump;
wherein the flexible part of the conformable insert comprises:
a flexible contact edge having a first thickness configured for contacting the skin along a body part and defining an active massage area; and
an elastically deformable middle section between the rigid base part and the flexible contact edge, the middle section configured to urge the flexible contact edge into conformity with a non-planar surface of the body part, and the middle section formed by a wall having a second thickness that is less than the first thickness;
wherein the middle section is collapsible in response to negative pressure imparted by the suction pump while the flexible contact edge conforms to the non-planar surface; and
wherein the flexible contact edge has a rounded shape and a width that is greater than the width of an elastically deformable wall that forms the middle section.
